(19) United States
(12) Patent Application Publication
(10) Pub. No.: US 2010/0185661 A1
(43) Pub. Date: Jul. 22, 2010

(54) Method and System for Negative Keyword Recommendations

(75) Inventors: Matthew Scott MALDEN, Vallejo, CA (US); John Ludwig COKER, Atherton, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: YIELD SOFTWARE, INC., San Mateo, CA (US)

(21) Appl. No.: 12/577,703

(22) Filed: Oct. 12, 2009

Related U.S. Application Data
(63) Continuation-in-part of application No. 12/414,171, filed on Mar. 30, 2009.
Application No. 12/414,171 is a continuation-in-part of application No. 12/346,589, filed on Dec. 30, 2008.

(51) Int. Cl. G06F 17/30

(52) U.S. Cl. 707/769; 707/E17.014; 707/736

(57) ABSTRACT

Effectiveness of search terms is determined. The search terms are classified to include effective search terms and ineffective search terms. An exclusion keyword list based on ineffective search terms is created. The ineffective search terms that conflict with the effective search terms are removed from the exclusion keyword list. Negative keywords are determined.

### RELATED APPLICATIONS

The present application is a continuation-in-part application of U.S. patent application Ser. No. 12/414,171, filed on Mar. 30, 2009 and entitled “Method and System for Negative Keyword Recommendations,” which is a continuation-in-part application of U.S. patent application Ser. No. 12/346,589, filed on Dec. 30, 2008 and entitled “Method and System for Negative Keyword Recommendations,” all the disclosures of which are hereby incorporated herein by reference.

### FIELD OF THE INVENTION

The present application relates to Internet searching and, in particular, a method and system for negative keyword recommendations.

### BACKGROUND

Many persons use the Internet to makes purchases. In the purchasing process, users may employ search engines to find desired products and services. Thus, many businesses offering products and services often list advertisements in search engine results to gain exposure to potential customers.

Advertisers may bid on a keyword, including one or more words, deemed relevant to their targeted customers. When a user enters one or more words, called a search term, for a search engine query, the search engine matches the search term with a list of keywords on which advertisers have bid. The advertisements of the advertisers will appear adjacent to the search results for the search term. Usually, one of the main criteria that determines the order of appearance of the advertisements is the amount of money bid for the keywords that matches the search term. The advertisements of the highest bidders will typically appear near the top of the search results.

Pay per click (PPC) is an Internet advertising model used in connection with search engines. In this model, advertisers only pay when a user actually clicks on an advertisement provided by a particular advertiser. Clicking on such an advertisement typically leads the user to the advertiser's website. The lower the cost per click (CPC) of a particular advertisement can indicate a more cost effective advertisement to an advertiser. However, advertisers often also track the success of an advertisement by determining the conversion rate associated with the advertisement.

Advertisers often bid on numerous keywords in their marketing campaigns. Each keyword will result in various levels of traffic and conversion rates at different costs. If an advertisement for a particular keyword does not cost effectively generate sufficient conversion rates or otherwise attract levels of audience interest desired by the advertiser, the keyword should be identified and eliminated from the marketing campaign.

### SUMMARY

In one embodiment of the present invention, effectiveness of search terms is determined. The search terms are classified to include effective search terms and ineffective search terms. An exclusion keyword list based on ineffective search terms is created. The ineffective search terms that conflict with the effective search terms are removed from the exclusion keyword list. Negative keywords are determined.

Many other features and embodiments of the present invention will be apparent from the accompanying drawings and from the following detailed description.

### BRIEF DESCRIPTION OF THE DRAWINGS

The present disclosure is illustrated by way of example and not limited in the figures of the accompanying drawings in which like references indicate similar elements.

FIG. 1 illustrates a system of recommending negative keywords in accordance with one embodiment of the present invention.

FIG. 2 illustrates a method of recommending negative keywords in accordance with one embodiment of the present invention.

FIG. 3 illustrates a method of determining search term effectiveness in accordance with one embodiment of the present invention.

FIG. 4 illustrates a method of creating an exclusion keyword list in accordance one embodiment of the present invention.

### DETAILED DESCRIPTION

In the following description, for purposes of explanation, numerous specific details are set forth in order to provide a thorough understanding of the description. It will be apparent, however, to one skilled in the art that embodiments of the disclosure can be practiced without these specific details. In some instances, structures and devices are shown in block diagram form in order to avoid obscuring the description. In other instances, functional block diagrams are shown to represent data and logic flows.

Reference in this specification to “one embodiment,” “an embodiment,” “other embodiments” or the like means that a particular feature, structure, or characteristic described in connection with the embodiment is included in at least one embodiment of the disclosure. The appearances of, for example, the phrase “in one embodiment” in various places in the specification are not necessarily all referring to the same embodiment, nor are separate or alternative embodiments mutually exclusive of other embodiments.

Moreover, whether or not there is express reference to an “embodiment” or the like, various features are described which may be exhibited by some embodiments and not by others. Similarly, various requirements are described which may be requirements for some embodiments but not other embodiments.

The present invention is a method and system for recommending negative keywords. The present invention can be used with a variety of Internet advertising models. One such example is pay per click (PPC), an Internet advertising model used in connection with search engines. The present invention can also be used with various other advertising models, such as Cost Per Acquisition (CPA), as well as still others.

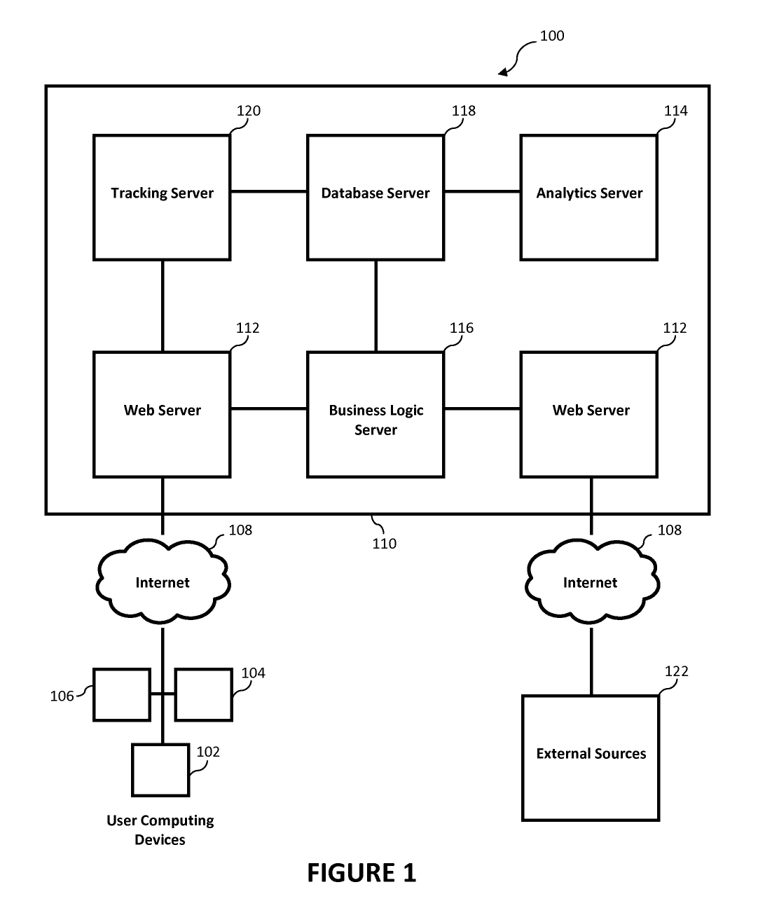

FIG. 1 illustrates a system 100 of recommending negative keywords in accordance with one embodiment of the present invention. In one embodiment, the present invention can be used in connection with a search engine. In another embodiment, the present invention can be used in connection with any web site having a search capability involving use of advertisements. The system 100 includes user computing devices 102, 104 and 106, Internet 108, a platform 110, and external sources 122. The platform includes web server 112, an analytics server 114, business logic server 116, database server 118, and tracking server 120. Internet users can access the internet 108 via user computing devices 102, 104 and 106 to reach a web site. When a web browser of one of the user computing devices 102, 104 and 106 requests a web page from a website of an advertiser who is using the platform 110, the request is sent over the Internet 108 and the website is rendered by the advertiser's web server 124. The advertiser's website, or web page, has a tracking code (also known as a “tracker”), which is provided to the advertiser to be placed on the advertiser's website. The tracking code is passed over the Internet 108 back to the user computing device 102, 104, 106 that initiated the request and the web page is displayed and the tracking code is executed in the web browser thereof. Then, the tracking code in the web browser sends information, called tracking data, about the user of the one of the user computing devices 102, 104, 106 over the Internet 108 to the web server 112 of the platform 110. Such information can include, for example, the web page requested, the prior site visited, and any search terms entered by the user of the one of the user computing devices 102, 104, 106. The tracking data is then passed to the tracking server 120 and stored in the database server 118. The analytics server 114 compiles and aggregates data from the database server 118 and stores the aggregations in the database server 118. The business logic server also retrieves external data from external sources 122 over the internet 108 through the web server 112 and stores that information in the database server 118. Then, the business logic server 116 accesses the database server 118 to determine the negative keyword list.

As an example to illustrate an embodiment of the present invention, assume that a residential real estate agent is an advertiser who bids on the following keywords: “real estate” and “residential real estate.” Bids are placed on the keywords using different match types, as discussed in more detail below. It will be appreciated that this exemplary illustration of a residential real estate agent as an advertiser, which continues below, is discussed as merely one of countless applications of the present invention and its many embodiments. This illustration is not to limit the scope of the present invention and its many embodiments.

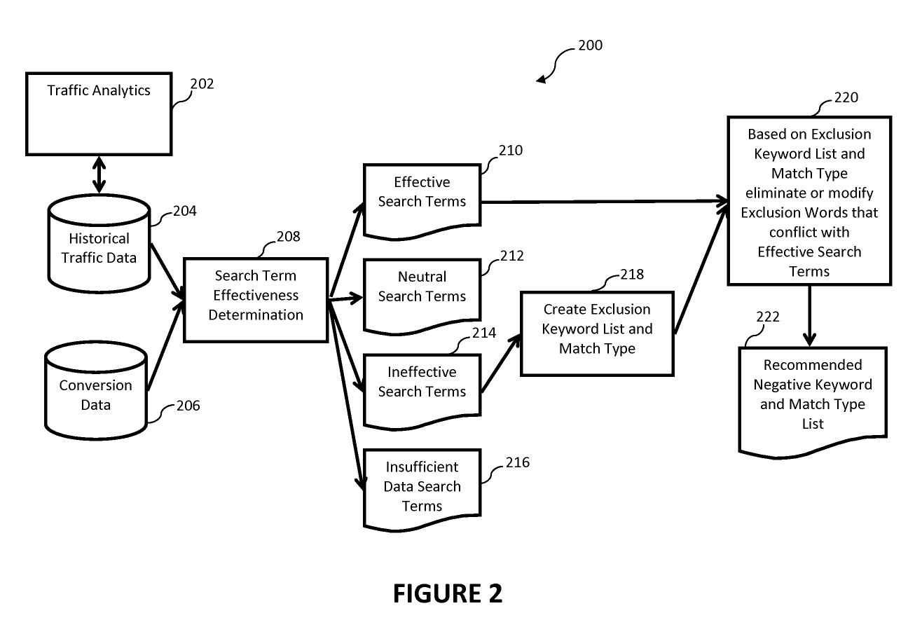

FIG. 2 illustrates a functional block diagram and method 200 of negative keyword recommendations in accordance with one embodiment of the present invention. The method 200 includes traffic analytics function 202, historical traffic database 204, conversion database 206, search term effectiveness determination function 208, effective search terms list 210, neutral search terms list 212, ineffective search terms list 214, insufficient data search terms list 216, create exclusion keyword list and match type function 218, elimination function 220, and recommended negative keyword and match type list 222.

The historical traffic database 204 represents information collected by the tracking server 120 regarding visitors to a particular website. In one embodiment, the database server 118 includes the historical traffic database 204. In one embodiment, the particular web page is requested by the user computer devices 102, 104, 106 and provided by the web server 112. The historical traffic database 204 stores data collected from the tracking server 120 and includes information such as the identity of the visitor, what web page the visitor viewed, where the visitor came from, what search engine the visitor used, what search term the visitor searched on, etc. The historical traffic database 204 also stores information about the activity of the visitor on the website during her visit to the website. Such information includes the duration of the visit, whether the visitor visited other parts of the website, what parts of the website were visited, etc. Information included in the historical traffic database 204 may include data, for example cost per click, that may come from, for example, search engines and other sources.

The traffic analytics block 202 runs analytics applications on the historical traffic data 204 to aggregate the data in a variety of ways. In one embodiment, the analytics server 114 includes the traffic analytics block 202. For example, the traffic analytics data may aggregate and weight traffic received from a particular search engine by users searching on a particular search term. The information aggregated may include, for example, the number of clicks, cost per click, and bounce rate (i.e., how many people click on a website advertisement but immediately leave the website).

The conversion database 206 represents the collection and calculation of information relating to conversion, such as conversion value and conversion rate. In one embodiment, the database server 118 includes the conversion database 206. A conversion is a success metric for action taken by a visitor that is desired by the website. A conversion can be, for example, the purchase of a good or service by the visitor, downloading of a newsletter by the visitor, reaching a certain page of the website, etc. Conversions can be assigned a numerical value to quantitatively describe the value to the business. Conversion rate is an indication of how many visitors to a website actually took action that was desired by the website in comparison to the total number of visitors to the website.

Conversion rates can be used to analyze the effectiveness of certain search terms. As an illustration, assume that a website advertiser placed a bid on a keyword that displayed an advertisement when a user searched on the search term “residential real estate.” Assume further that the advertisement for the website advertiser was clicked 300 times, which in turn led to 50 conversions. By comparison, and as further illustration, assume the website advertiser also placed a bid on a keyword that displayed an advertisement when a user searched on the search term “real estate agent.” Assume further that this search term led to 400 clicks, which in turn led to 40 conversions. In this hypothetical, the conversion rate for the search term “residential real estate” is larger than the conversion rate for the search term “real estate agent.” Accordingly, the website advertiser likely would conclude that the search term “residential real estate” is relatively more effective.

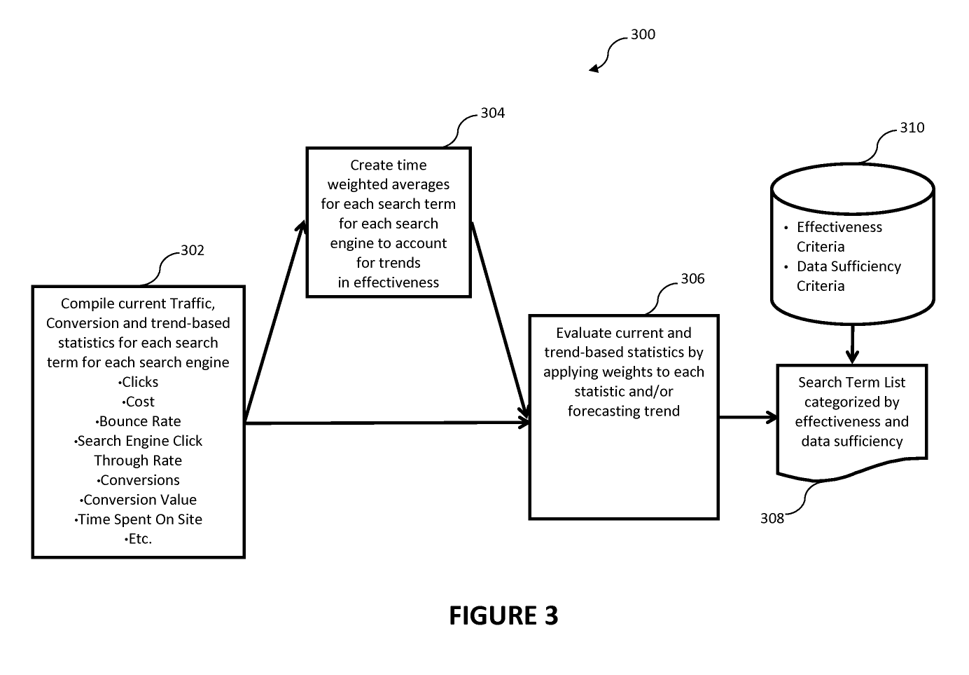

The method 200 proceeds to the search term effectiveness determination block 208 from the historical traffic database 204 and the conversion database 206. FIG. 3 illustrates a functional block diagram and method 300 for the search term effectiveness determination block 208. The method 300 includes a current statistics compilation block 302, time weighted averages calculation block 304, statistics evaluation block 306, search term list categorization list 308, and criteria database 310.

The current statistics compilation block 302 compiles current traffic and conversion statistics and trend-based statistics for each search term for each search engine, such as those provided by Yahoo!, Google, MSN, etc. The statistics include, for example, the metrics of number of clicks, bounce rate, search engine click through rate (i.e., a ratio indicating how many times an advertisement is clicked after appearing as a search result), conversions, conversion value, time spent on the website, cost (i.e., the amount of money spent on the advertisement for the search term), etc. In one embodiment, statistics can be gathered separately for natural search traffic and paid search traffic. In one embodiment, traffic and conversion statistics can be focused on or limited to certain geographic locations or times of day as well as other considerations. In one embodiment, statistics for a search term can be enhanced by weighting and aggregating statistics for similar or related search terms. In one embodiment, the system can expand the list of search terms by including words or groups of words appearing in one or more search terms, and the system can calculate statistics for those additional search terms by weighting and aggregating statistics of other search terms.

Following the exemplary illustration of a residential real estate agent as advertiser, data is compiled in accordance with one embodiment of the present invention regarding click and conversion statistics for users who entered the following search terms:

| SEARCH TERM | CLICKS | CONVERSIONS |
|---|---|---|
| real estate | 500 | 50 |
| real estate agent | 400 | 40 |
| residential real estate | 300 | 50 |
| california real estate | 100 | 1 |
| commercial real estate | 50 | 0 |
| real estate for rent | 10 | 0 |
| real estate association | 100 | 0 |
| real estate classes | 2 | 0 |
| real | 400 | 0 |

In one embodiment, the method 300 proceeds to the time weighted averages creation block 304, which creates time weighted averages of traffic and conversion statistics for each search term for each search engine to account for trends in effectiveness. The effectiveness of search term, as reflected by traffic and conversion statistics, will vary over time. Very often, more recent statistics more meaningfully reflect search term effectiveness than less recent statistics. As a result, in one embodiment, the time weighted averages creation block 304 weighs recent statistics more heavily compared to less recent statistics.

The method 300 proceeds to the statistics evaluation block 306 from the current statistics compilation block 302 and the time weighted averages creation block 304. The statistics evaluation block 306 evaluates current and trend-based statistics by applying additional weighting. The additional weighting applied to current and trend-based statistics could account for such factors as, for example, their historical relative importance in forecasting keyword effectiveness.

The method 300 proceeds to the search term list by category 308. The search term list by category 308 is determined based on the effectiveness of search terms calculated in the statistics evaluation block 306 combined with the application of effectiveness criterion and data sufficiency criterion stored in the criteria database 310. As an example, in one embodiment, conversion rate could be an effectiveness criterion. In such an instance, for example, a search term could be determined to be “effective” if its conversion rate is above 20% and “ineffective” if its conversion rate is below 1%. As another example, profitability of a search term could be an effectiveness criterion. As yet another example, a data sufficiency criterion could be that the search term receives more than 100 clicks in a specific period of time and, if it receives an equal or lesser amount of clicks, the search term could be placed on the insufficient data search terms list 216. In one embodiment, other effectiveness and data sufficiency criteria could include a variety of other factors such as visitors, conversions, bounce rate and time on site. Each search term is categorized, as described above, into one of four categories, as shown in FIG. 2: effective, neutral, ineffective, and insufficient data.

From the search term effectiveness determination block 208, the method 200 proceeds to the effective search terms list 210, the neutral search terms list 212, the ineffective search terms list 214, and the insufficient data search terms list 216.

In one embodiment, an advertiser can dynamically determine the conversion value of a user's activities on the advertiser's website for purposes of classifying the search term as effective, ineffective, or neutral. For example, if a customer purchases products from the company's web site, the conversion value may be the profit derived from that single transaction. In yet another example, the conversion value may be calculated as the lifetime value or profit of that customer estimated based on the type of products that customer purchased.

When insufficient data precludes classification of a search term as effective, neutral, or ineffective, then the search term is classified as having insufficient data with respect to the insufficient data search terms block 216. In one embodiment, a threshold frequency of the clicks from a search term is necessary before the search term is classified as effective, neutral, or ineffective. For example, a threshold frequency may be set so that if a search term was clicked by a user only once, and the user did not convert, then there is no attempt to categorize the search term as effective, neutral, or ineffective. Accordingly, in the example, the search term is associated as having insufficient data.

Continuing the exemplary illustration of a residential real estate agent as advertiser, search terms may be categorized in accordance with one embodiment of the present invention as follows:

| | |
|---|---|
| real estate | Effective |
| real estate agent | Effective |
| residential real estate | Effective |
| california real estate | Neutral |
| commercial real estate | Ineffective |
| real estate for rent | Insufficient Data |
| real estate association | Ineffective |
| real estate classes | Insufficient Data |
| real | Ineffective |

Accordingly, the exclusion keywords would be “commercial real estate,” “real estate association” and “real.”

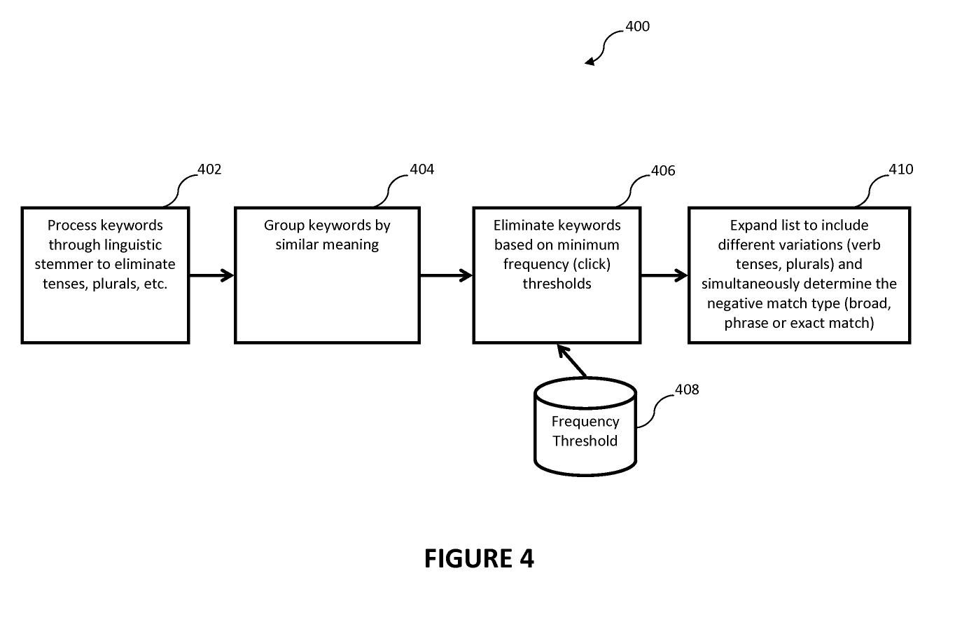

The method 200 proceeds from the ineffective search terms block 214 to the create exclusion keyword list and match type block 218. FIG. 4 illustrates a functional block diagram and method 400 for the create exclusion keyword list and match type block 218. The create exclusion keyword list and match type block 218 includes a linguistic stemmer block 402, meaning grouping block 404, keyword elimination block 406, a frequency threshold database 408, and a list expansion block 410.

The method 400 begins at the linguistic stemmer block 402. The linguistic stemmer block 402 may process words through a linguistic stemmer to standardize word tense, plural forms of words, and other verbal and grammatical variations of words within keywords. For example, the keyword “real estate for rent” and the keyword “real estate for renting” would be processed and normalized to a single form. In one embodiment, the linguistic stemmer block 402 may be implemented with one or more of any known stemming techniques. For example, with respect to keywords in the English language, Porter stemming or taking the first five letters of a keyword can be employed. It will be appreciated by those of ordinary skill in the art that the desired stemming technique will depend on many factors including the language of the keyword, for example, English, Hindi, Chinese, etc.

The method 400 proceeds to the meaning grouping block 404, which may groups keywords by the similarity in their meaning. For example, the keyword “real estate” is to a degree similar to the keyword “property.” In one embodiment, for a keyword in the English language, the meaning grouping block 404 may be implemented by accessing a database in the public domain known as Wordnet, which is run by Princeton University. In one embodiment, other databases, including proprietary databases, may be employed.

The method 400 proceeds to keyword elimination block 406, where keywords are eliminated based on the minimum frequency thresholds provided by the threshold frequency database 408. If keywords, after being processed by the linguistic stemmer block 402 and the meaning grouping block 404, do not exceed the frequency threshold, then they are eliminated from the exclusion word list.

The method 400 proceeds to the list expansion block 410, where the exclusion word list may be expanded to include different variations of keywords, such as verb tenses and plural word forms, and the negative match type associated with each keyword is simultaneously determined. Exemplary negative match type may include, for example, “exact” match, “phrase” match, and “broad” match. For “exact” match, a search term entered by a user for a search must exactly match the exclusion keyword. For “phrase” match, a search term entered by a user for a search is the same as or includes the exclusion keyword. For “broad” match, a search term entered by a user for a search need only be associated with the exclusion keyword by a predetermined relationship. In one embodiment, one or more negative match types of broader or narrower scope may be used. The presence of a negative match for a selected negative match type results in an associated advertisement not appearing as an advertisement for any search where the search term contains the negative keyword or a variation of the keyword based on the negative match type. The list expansion block 410 assigns a broader matching criterion (e.g., broad match) to an exclusion keyword when the exclusion keyword is more clearly negative. The list expansion block 410 assigns a narrower matching criterion (e.g., exact match) to an exclusion keyword when the exclusion keyword is less clearly negative.

The method 200 proceeds to elimination block 220, which eliminates or modifies exclusion keywords that conflict with effective search terms based on the exclusion word list and match type. The keywords identified from the create exclusion keyword list and match type block 218 are compared against the search terms identified from effective search terms list 210. If a keyword identified from the create exclusion keyword list and match type block 218 is identical to or included as part of search term identified from effective keywords list 210, then such a keyword is eliminated or modified from the exclusion word list and match type to ensure it doesn't conflict with any effective search terms. The keyword is eliminated to preserve the search terms that have been already determined to be effective.

The method 200 proceeds to the negative keyword and match type list recommendation block 222, where the negative keywords and associated match types are identified in a list in accordance with the present invention.

Continuing the exemplary illustration of a residential real estate agent as advertiser, exclusion words that are part of effective search terms are eliminated in accordance with one embodiment of the present invention. For example, the exclusion word “real” is eliminated as a negative keyword because it is included in the effective search terms “real estate,” “real estate agent” and “residential real estate.” As another example, the term “commercial” in the ineffective search term “commercial real estate” is retained but the portion “real estate” is eliminated because it is an effective search term. Likewise, the term “association” in the ineffective search term “real estate association” is retained but the portion “real estate” is eliminated because it is an effective search term. As a result, the negative keyword list would contain the negative keywords “commercial” and “association.”

As will be readily appreciated by those having ordinary skill in the art, the identification of negative keywords is important to advertisers for myriad reasons. For example, once negative keywords are determined, advertisers can avoid bidding on keywords containing them to save unjustified expense in their advertising campaigns. As another example, advertisers can register or otherwise present negative keywords to search engines to strategically stop undesirable traffic that otherwise would be directed to the advertiser and its website.

An embodiment of the invention relates to a computer storage product with a computer-readable or machine-accessible medium having executable instructions or computer code thereon for performing various computer-implemented operations. The term “computer-readable medium” or “machine-accessible medium” is used herein to include any medium that is capable of storing or encoding a sequence of executable instructions or computer code for performing the operations described herein. The media and computer code can be those specially designed and constructed for the purposes of the invention, or can be of the kind well known and available to those having ordinary skill in the computer software arts.

Examples of computer-readable media include computer-readable storage media such as: magnetic media such as hard disks, floppy disks, and magnetic tape; optical media such as Compact Disc-Read Only Memories (“CD-ROMs”) and holographic devices; magneto-optical media such as optical disks; and hardware devices that are specially configured to store and execute program code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as produced by a compiler, and files containing higher level code that are executed by a computer using an interpreter. For example, an embodiment of the invention may be implemented using Java, C++, or other programming language and development tools. Additional examples of computer code include encrypted code and compressed code. Another embodiment of the invention can be implemented in hard wired circuitry in place of, or in combination with, computer code.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit, and scope of the invention. All such modifications are intended to be within the scope of the claims appended hereto. In particular, while the methods disclosed herein have been described with reference to particular operations performed in a particular order, it will be understood that these operations may be combined, sub-divided, or reordered to form an equivalent method without departing from the teachings of the invention. Accordingly, unless specifically indicated herein, the order and grouping of the operations is not a limitation of the invention.

We claim:

1. A computer implemented method comprising:
determining, via a physical computing device, effectiveness of keywords;
classifying the search terms to include effective search terms and ineffective search terms;
creating an exclusion keyword list based on the ineffective search terms;
removing from the exclusion keyword list the ineffective search terms that conflict with the effective search terms; and
determining negative keywords.

2. The method of claim 1 wherein the determining includes compiling statistics for each search term for each search engine based on one or more factors.

3. The method of claim 2 wherein the one or more factors include number of clicks, bounce rate, search engine click through rate, conversions, conversion value, and time spent on website.

4. The method of claim 2 wherein the determining further includes creating time weighted averages of the statistics.

5. The method of claim 2 wherein the determining further includes categorizing the search terms by an effectiveness criterion.

6. The method of claim 2 wherein the determining further includes categorizing the search terms by a data sufficiency criterion.

7. The method of claim 1 wherein the creating includes employing a linguistic stemmer.

8. The method of claim 7 wherein the creating further includes grouping the ineffective search terms by meaning.

9. The method of claim 7 wherein the creating further includes eliminating the ineffective search terms based on frequency thresholds.

10. The method of claim 7 wherein the creating further includes expanding the exclusion keyword list to include variations of the ineffective search terms.

11. The method of claim 7 wherein the creating further includes associating a negative match type with the ineffective search terms.

12. A machine-readable medium having stored thereon a set of instructions, which when executed by a machine, perform a method comprising:
determining effectiveness of keywords;
classifying the search terms to include effective search terms and ineffective search terms;
creating an exclusion keyword list based on the ineffective search terms;
removing from the exclusion keyword list the ineffective search terms that conflict with the effective search terms; and
determining negative keywords.

13. The method of claim 12 wherein the determining includes compiling statistics for each search term for each search engine based on one or more factors.

14. The method of claim 13 wherein the one or more factors include number of clicks, bounce rate, search engine click through rate, conversions, conversion value, and time spent on website.

15. The method of claim 13 wherein the determining further includes categorizing the search terms by a data sufficiency criterion.

16. The method of claim 12 wherein the creating includes employing a linguistic stemmer.

17. The method of claim 16 wherein the creating further includes grouping the ineffective search terms by meaning.

18. The method of claim 16 wherein the creating further includes eliminating the ineffective search terms based on frequency thresholds.

19. The method of claim 16 wherein the creating further includes expanding the exclusion keyword list to include variations of the ineffective keywords.

20. A computer system comprising:
at least one server to:
determine effectiveness of search terms;
classify the search terms to include effective search terms;
create an exclusion keyword list based on ineffective search terms;
remove from the exclusion keyword list the ineffective search terms that conflict with the effective search terms; and
determine negative keywords.
